(19) United States
(12) Patent Application Publication
(10) Pub. No.: US 2023/0252065 A1
(43) Pub. Date: Aug. 10, 2023

(54) COORDINATING SCHEDULES OF CRAWLING DOCUMENTS BASED ON METADATA ADDED TO THE DOCUMENTS BY TEXT MINING

(71) Applicant: International Business Machines Corporation, Armonk, NY (US)

(72) Inventors: TAIHEI MIYAMOTO, Tokyo (JP); KENTA WATANABE, Soka-shi (JP); Takahito Tashiro, Tokyo (JP); Yoshitaka Kurokawa, Tokyo (JP)

(21) Appl. No.: 17/650,394

(22) Filed: Feb. 9, 2022

(51) Int. Cl. G06F 16/38; G06F 16/35; G06F 16/31

(52) U.S. Cl. CPC G06F 16/38; G06F 16/35; G06F 16/31

(57) ABSTRACT

A computer-implemented method, a computer program product, and a computer system for coordinating schedules of crawling documents based on metadata added to documents by text mining. A computer system determines whether added metadata in internal documents or metadata in original documents necessitates that the original documents in at least two of respective data sources be crawled by an application with a same crawling schedule. A computer system changes respective crawling schedules of at least two of the respective data sources to the same crawling schedule, in response to determining that the same crawling schedule is needed. A computer system crawls the original documents in at least two of the respective data sources, according to the same crawling schedule.

### BACKGROUND

The present invention relates generally to crawling documents in data sources by an application, and more particularly to coordinating schedules of crawling documents based on metadata added to documents by text mining.

Search applications (such as IBM Watson Explorer and Watson Discovery) crawl original documents (such as text files, PDF files, Microsoft Word, Excel, and PowerPoint files) from original data sources (such as document management and storage systems). Then, search applications convert original documents to internal documents. Internal documents may be database records or indexed data, depending on the implementation.

The original documents and the internal documents have almost the same information, including document content and metadata (such as names of authors); however, formats of the original documents and the internal documents are different. The internal documents have additional information such as “field”. The “filed” might be added by the search application automatically. The “filed” may be also added by a user's manual operation.

In such an environment, periodical execution of crawling documents is involved. For an environment with multiple data sources, schedules of periodical crawling may be different for documents in different data sources or time lags of crawling documents may occur.

### SUMMARY

In one aspect, a computer-implemented method for coordinating schedules of crawling documents based on metadata added to documents by text mining is provided. The computer-implemented method includes determining whether added metadata in internal documents or metadata in original documents necessitates that the original documents in at least two of respective data sources be crawled by an application with a same crawling schedule. The computer-implemented method further includes, in response to determining that the same crawling schedule is needed, changing respective crawling schedules of at least two of the respective data sources to the same crawling schedule. The computer-implemented method further includes crawling the original documents in at least two of the respective data sources, according to the same crawling schedule.

In another aspect, a computer program product for coordinating schedules of crawling documents based on metadata added to documents by text mining is provided. The computer program product comprises a computer readable storage medium having program instructions embodied therewith, and the program instructions are executable by one or more processors. The program instructions are executable to: determine whether added metadata in internal documents or metadata in original documents necessitates that the original documents in at least two of respective data sources be crawled by an application with a same crawling schedule; in response to determining that the same crawling schedule is needed, change respective crawling schedules of at least two of the respective data sources to the same crawling schedule; and crawl the original documents in at least two of the respective data sources, according to the same crawling schedule.

In yet another aspect, a computer system for coordinating schedules of crawling documents based on metadata added to documents by text mining is provided. The computer system comprises one or more processors, one or more computer readable tangible storage devices, and program instructions stored on at least one of the one or more computer readable tangible storage devices for execution by at least one of the one or more processors. The program instructions are executable to determine whether added metadata in internal documents or metadata in original documents necessitates that the original documents in at least two of respective data sources be crawled by an application with a same crawling schedule. The program instructions are further executable to, in response to determining that the same crawling schedule is needed, change respective crawling schedules of at least two of the respective data sources to the same crawling schedule. The program instructions are further executable to crawl the original documents in at least two of the respective data sources, according to the same crawling schedule.

### BRIEF DESCRIPTION OF THE SEVERAL VIEWS OF THE DRAWINGS

FIG. 1 is a diagram illustrating a system for coordinating schedules of crawling documents based on metadata added to documents by text mining, in accordance with one embodiment of the present invention.

FIG. 2 is a flowchart showing operational steps for coordinating schedules of crawling documents based on metadata added to documents by text mining, in accordance with one embodiment of the present invention.

FIG. 3 is a diagram illustrating a first use case of coordinating schedules of crawling documents based on metadata added to documents by text mining, in accordance with one embodiment of the present invention.

FIG. 4 is a diagram illustrating a second use case of coordinating schedules of crawling documents based on metadata added to documents by text mining, in accordance with one embodiment of the present invention.

FIG. 5 is a diagram illustrating components of a computer system or server, in accordance with one embodiment of the present invention.

FIG. 6 depicts a cloud computing environment, in accordance with one embodiment of the present invention.

FIG. 7 depicts abstraction model layers in a cloud computing environment, in accordance with one embodiment of the present invention.

### DETAILED DESCRIPTION

In an environment where periodical execution of crawling documents is involved, when the number of sentences or the number of data sources targeted for crawling is extremely large, occurrence of time lags in crawling documents may prevent consistent analysis. Embodiments of the present invention disclose a method of coordinating timing of subsequent crawling with the use of information of metadata (such as labels given to respective documents by text mining) so that relevant documents are crawled at the same timing.

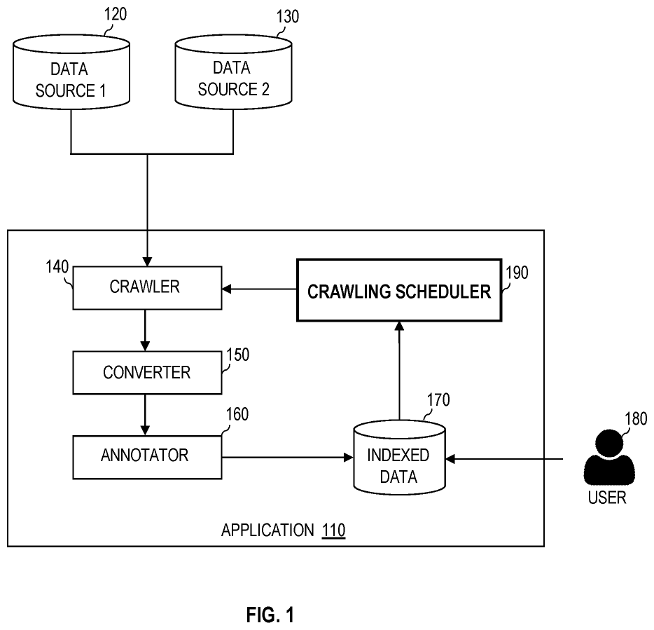

FIG. 1 is a diagram illustrating a system for coordinating schedules of crawling documents based on metadata added to documents by text mining, in accordance with one embodiment of the present invention. The system for coordinating schedules of crawling documents based on metadata added to documents by text mining includes application 110 and data sources (namely, data source 1 120 and data source 2 130). For the purpose of illustration, FIG. 1 shows two data sources. It should be appreciated that FIG. 1 provides only an illustration of one implementation and does not imply any limitations; the system for coordinating schedules of crawling documents may include any number of data sources.

Application 110 is a search application configured to crawl documents from data source 1 120 and data source 130. Examples of application 110 are IBM Watson Explorer and IBM Watson Discovery. Data source 1 120 and data source 2 130 are document management systems.

Application 110 includes crawler 140, converter 150, and annotator 160. Crawler 140 is a component that crawls original documents in data source 1 120 and data source 2 130. The original documents in the data source may include, for example, text files, PDF files, Microsoft Word, Excel, and PowerPoint files. Converter 150 is a component that converts the original documents crawled by crawler 140 from data source 1 120 and data source 2 130 into internal documents with a format handled in application 110. Annotator 160 is a component that automatically add additional information such as “filed” into the internal documents. In this document, the “field” may be called as “tag” or “flag”. Also, the additional information may be manually added by user 180. The annotated internal documents (which are with automatically or manually added metadata) are stored in indexed data 170.

One embodiment of the present invention adds a component crawling scheduler 190 to application 110. Crawling scheduler 190 is integrated into application 110. FIG. 1 shows the added component crawling scheduler 190 in application 110. In another embodiment, a crawling scheduler may be a separate component from application 110. Crawling scheduler 190 determines whether the added metadata to the internal documents or pre-existing metadata in the original documents necessitates that at least two of respective data sources be crawled with a same crawling schedule. In a case where the added metadata or the pre-existing metadata necessitates the same crawling schedule, crawling scheduler 190 changes respective crawling schedules of the at least two of the respective data sources to the same crawling schedule. Crawling scheduler 190 provides to crawler 140 with the same crawling schedule for crawling the original documents. Crawler 140 crawls original documents in the at least two of the respective data sources, according to the same crawling schedule.

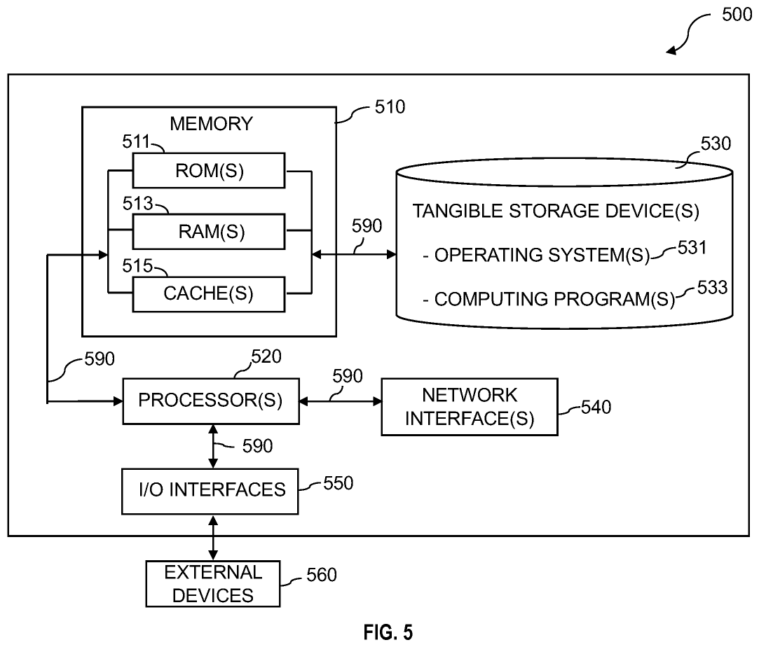

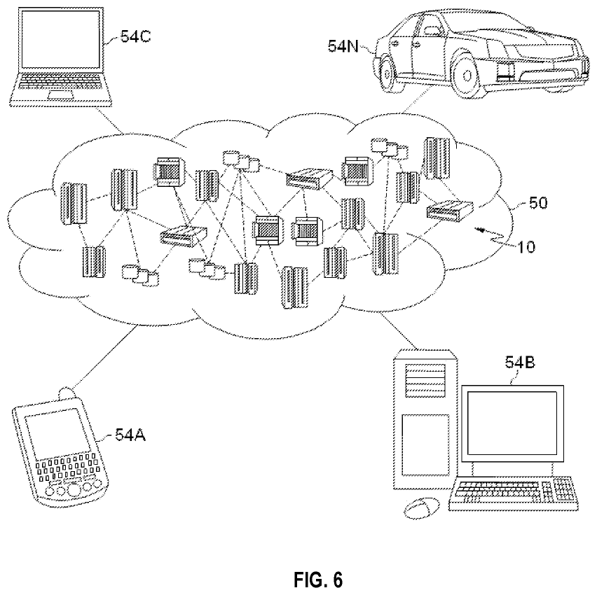

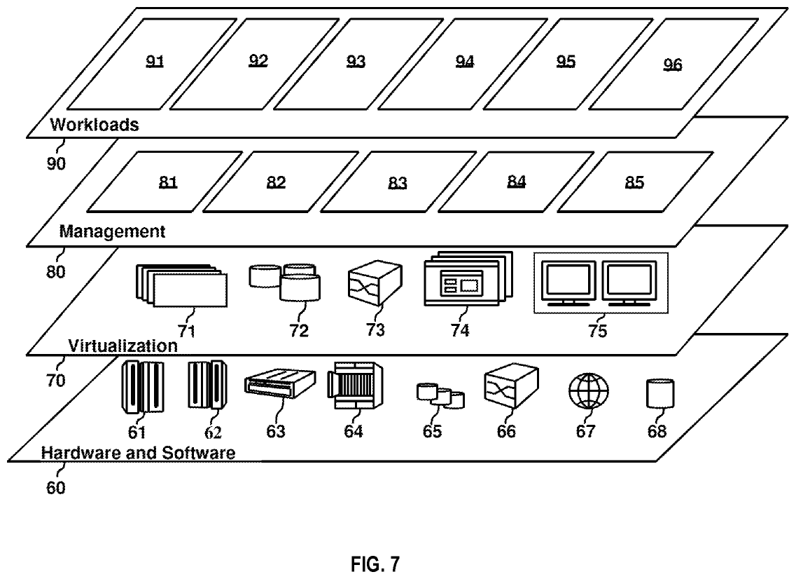

Crawling scheduler 190 as well as application 110 is implemented on one or more servers. A server is described in more detail in later paragraphs with reference to FIG. 5. The operational steps may be implemented in a cloud computing environment. The cloud computing environment is described in more detail in later paragraphs with reference to FIG. 6 and FIG. 7.

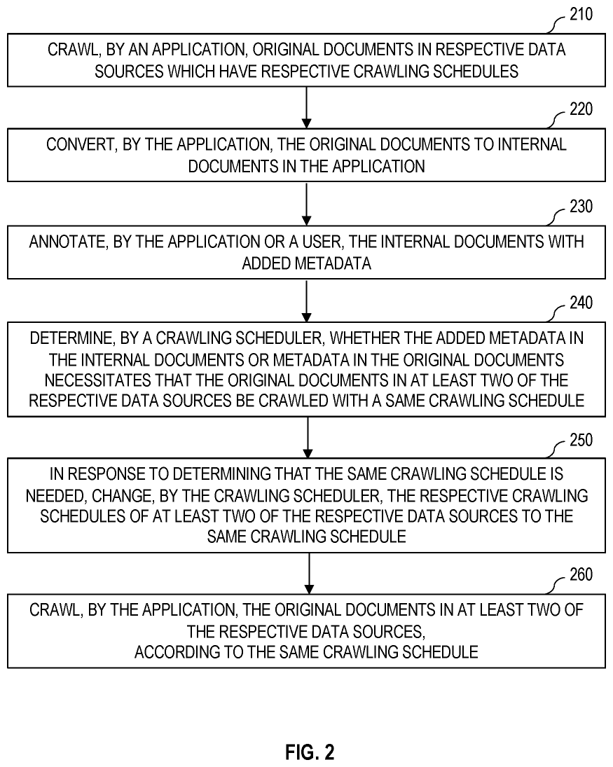

FIG. 2 is a flowchart showing operational steps for coordinating schedules of crawling documents based on metadata added to documents by text mining, in accordance with one embodiment of the present invention. At step 210, an application crawls original documents in respective data sources which have respective crawling schedules. In the embodiment shown in FIG. 1, crawler 140 in application 110 crawls the original documents in data source 1 120 and data source 2 130 which have different crawling schedules.

At step 220, the application converts the original documents to internal documents in the application. In the embodiment shown in FIG. 1, converter 150 in application 110 converts the original documents in data source 1 120 and data source 2 130 to internal documents in application 110.

At step 230, the application annotates the internal documents with added metadata. In the example shown in FIG. 1, annotator 160 in application 110 annotates the internal documents. In another embodiment, the application receives annotated metadata from a user. In the example shown in FIG. 1, application 110 receives the annotated metadata from user 180.

At step 240, a crawling scheduler determines whether the added metadata in the internal documents or metadata in the original documents necessitates that the original documents in at least two of the respective data sources be crawled with a same crawling schedule. In one embodiment, the crawling scheduler is a component of the application; for example, as shown in FIG. 1, crawling scheduler 190 is a component of application 110. In another embodiment, the crawling scheduler may be a separate component from application 110. The added metadata in the internal documents is added at step 230 either by the application or by the user; for example, the added metadata may be labels or tags added by the application or by the user, and the added metadata may be a classification of some documents classified by the application. The metadata in the original documents is pre-existing information attached to the original documents; for example, an access-control list (ACL) is metadata originally attached to some original documents in the data sources.

At step 250, in response to determining that the same crawling schedule is needed (the added metadata in the internal documents or metadata in the original documents necessitates that the original documents in at least two of the respective data sources be crawled with the same crawling schedule), the crawling scheduler changes the respective crawling schedules of at least two of the respective data sources to the same crawling schedule. For example, if the internal documents crawled from the respective date sources are classified into a same class but the original documents have scheduled to be crawled with different schedules, the same crawling schedule is needed for the original documents. In another example, if the original documents in the respective date sources are with an access control list (ACL) but the original documents have scheduled to be crawled with different schedules, the same crawling schedule is needed for the original documents with the ACL. In these two examples, the crawling scheduler changes the previous different crawling schedules for different data sources to the same crawling schedule.

Upon receiving the same crawling schedule from the crawling scheduler, at step 260, the application crawls the original documents in at least two of the respective data sources, according to the same crawling schedule. In the embodiment shown in FIG. 1, crawler 140 in application 110 crawls the original documents in data source 1 120 and data source 2 130 at the same time.

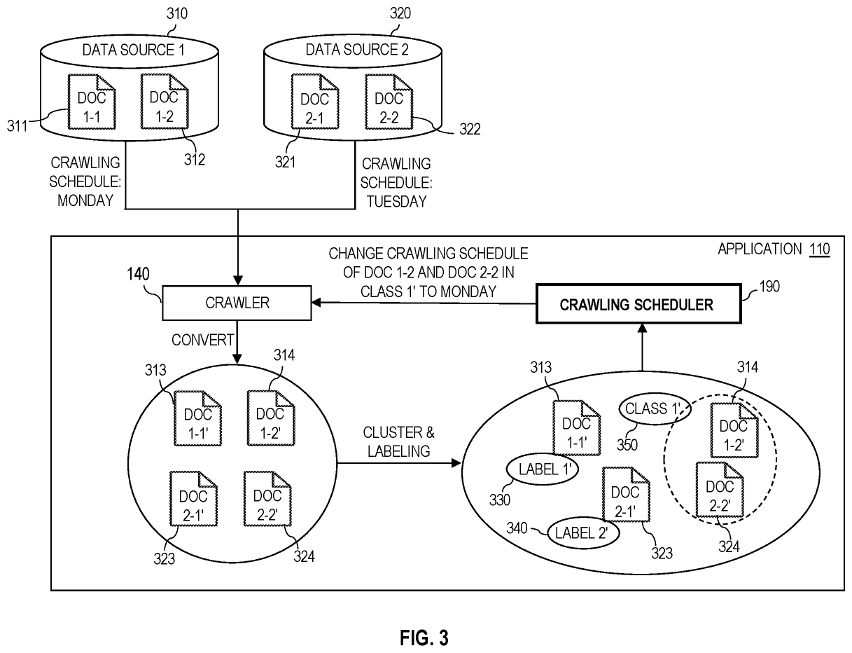

FIG. 3 is a diagram illustrating a first use case of coordinating schedules of crawling documents based on metadata added to documents by text mining, in accordance with one embodiment of the present invention. As shown in FIG. 3, there are two data sources, namely data source 1 310 and data source 2 320. Data source 1 310 includes original document DOC 1-1 311 and original document DOC 1-2 312. Data source 2 320 includes original document DOC 2-1 321 and original document DOC 2-2 322. Crawler 140 in application 110 crawls original document DOC 1-1 311, original document DOC 1-2 312, original document DOC 2-1 321, and original document DOC 2-2 322. Crawler 140 has been scheduled to crawl original document DOC 1-1 311 and original document DOC 1-2 312 in data source 1 310 on Mondays, while crawler 140 has been scheduled to crawl original document DOC 2-1 321 and original document DOC 2-2 322 data source 2 320 on Tuesdays. The documents are crawled at different time.

The original documents have a format handled in data source 1 310 and data source 2 320. Application 110 converts original document DOC 1-1 311 to internal document DOC 1-1′ 313, original document DOC 1-2 312 to internal document DOC 1-2′ 314, original document DOC 2-1 321 to internal document DOC 2-1′ 323, and original document DOC 2-2 322 to internal document DOC 2-2′ 324. The internal documents have a format handled in application 110.

Referring to FIG. 3, application 110 clusters and labels the internal documents. Application 110 labels internal document DOC 1-1′ 313 with label 1′ 330 and labels internal document DOC 2-1′ 323 with label 2′ 340. For example, internal document DOC 1-1′ 313 is labeled as “important” and internal document DOC 2-1′ 323 is labeled as “confidential”. Application 110 clusters internal document DOC 1-2′ 314 and internal document DOC 2-2′ 324 into class 1′ 350. For example, internal document DOC 1-2′ 314 and internal document DOC 2-2′ 324 are classified as “accident reports”.

In this use case, internal document DOC 1-2′ 314 and internal document DOC 2-2′ 324 fall in a same field or class (e.g., “accident reports”); however, they are in data source 1 310 and data source 2 320 and are crawled at different time. In an attempt to analyze same field or class (e.g., “accident reports”), different final update dates/times among documents may cause a discrepancy of information. Therefore, a crawling schedule should be coordinated so that the documents of the same field or class in data source 1 310 and data source 2 320 are crawled at the same time (or with a same crawling schedule).

Crawling scheduler 190 determines that classification of DOC 1-2′ 314 and internal document DOC 2-2′ 324 into the same class (class 1′ 350) necessitates that original document DOC 1-2 312 in data source 1 310 and original document DOC 2-2 322 in data source 2 320 be crawled with a same crawling schedule. Crawling scheduler 190 changes the original crawling schedules (for example Mondays for documents in data source 1 310 and Tuesdays for documents in data source 2 320) to the same crawling schedule (for example Mondays for both documents in data source 1 310 and documents in data source 2 320). Upon receiving the same crawling schedule from crawling scheduler 190, crawler 140 crawls both documents in data source 1 310 and documents in data source 2 320 according to the same crawling schedule (e.g., Mondays).

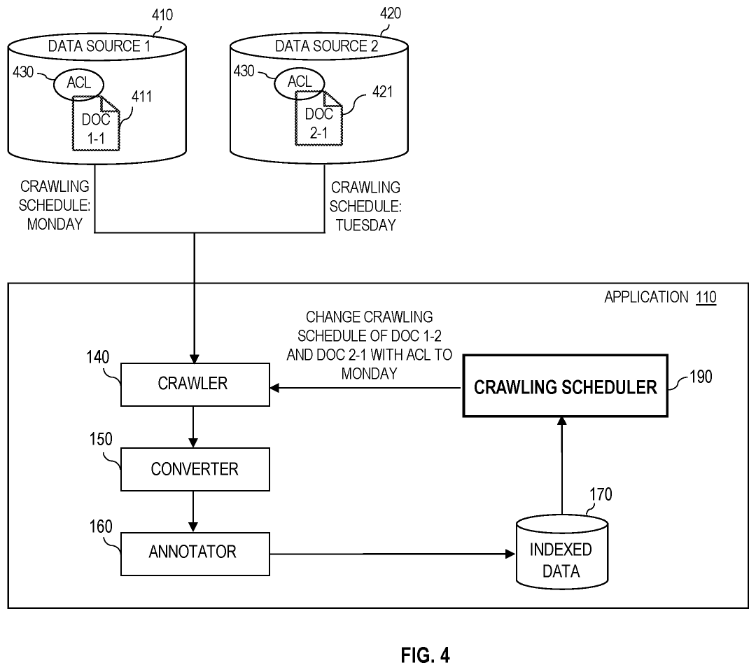

FIG. 4 is a diagram illustrating a second use case of coordinating schedules of crawling documents based on metadata added to documents by text mining, in accordance with one embodiment of the present invention. As shown in FIG. 4, there are two data sources, namely data source 1 410 and data source 2 420. Data source 1 410 includes original document DOC 1-1 411 which has access-control list ACL 430. Data source 2 520 includes original document DOC 2-1 421 which has also access-control list ACL 430.

In embodiment shown in FIG. 4, application 100 provides a function of so-called secure(d) search or document-level security. Secure search is a function to display only search target data accessible to a certain user, based on access-control list ACL 430 set for original document DOC 1-1 411 in data source 1 410 and original document DOC 2-1 421 in data source 2 420.

According to a method called pre-filtering (early binding) which is one of methods to realize the secure search, when application 100 imports documents and creates an index, application 100 also obtains the ACL and records it in the index. An ID of the search user and an ID of the group to which the user belongs are verified with the ACL in the index when a search is conducted, thus whether documents can be displayed or not in a search result is determined.

Pre-filtering is processed at high speed because whether documents can be displayed or not in a search result can be decided merely by determining whether a user making a search is included in the ACL in a created index. However, any change of ACL made after creation of an index is not reflected in a search result until a data source is recrawled and the index is updated.

When confidential information with same attributes is stored throughout multiple data sources (for example, both DOC 1-1 411 and DOC 2-1 421 are with the same access-control list ACL 430 but in different data sources), different crawl intervals between the data sources will cause ACL changes to reflect only on some data sources in the search results. This will lead to a failure in appropriate security protection.

Crawling scheduler 190 determines that it is necessary to crawl DOC 1-1 411 in data source 1 410 and DOC 2-1 421 in data source 2 420 with a same crawling schedule, for the purpose of the appropriate security protection. Crawling scheduler 190 changes the original crawling schedules (for example Mondays for DOC 1-1 411 in data source 1 10 and Tuesdays for DOC 2-1 421 in data source 2 420) to the same crawling schedule (for example Mondays for both DOC 1-1 411 and DOC 2-1 421). Upon receiving the same crawling schedule from crawling scheduler 190, crawler 140 crawls both DOC 1-1 411 and DOC 2-1 421 according to the same crawling schedule (e.g., Mondays).

Crawling scheduler 190 adds a same label of the same crawling schedule to confidential documents (DOC 1-1 411 and DOC 2-1 421 with access-control list ACL 430) stored in multiple data sources (data source 1 410 and data source 2 420), and thus the confidential documents are crawled with the same crawling schedule. The same crawling schedule will reflect ACL changes on all data sources in the search results; therefore, failure in appropriate security protection is prevented.

FIG. 5 is a diagram illustrating components of computer system or server 500, in accordance with one embodiment of the present invention. It should be appreciated that FIG. 5 provides only an illustration of one implementation and does not imply any limitations; different embodiments may be implemented.

Referring to FIG. 5, computer system or server 500 includes processor(s) 520, memory 510, and tangible storage device(s) 530. In FIG. 5, communications among the above-mentioned components of computer system or server 500 are denoted by numeral 590. Memory 510 includes ROM(s) (Read Only Memory) 511, RAM(s) (Random Access Memory) 513, and cache(s) 515. One or more operating systems 531 and one or more computer programs 533 reside on one or more computer readable tangible storage device(s) 530.

Computer system or server 500 further includes I/O interface(s) 550. I/O interface(s) 550 allows for input and output of data with external device(s) 560 that may be connected to server 500. Computer system or server 500 further includes network interface(s) 540 for communications between computer system or server 500 and a computer network.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the C programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 6, illustrative cloud computing environment 50 is depicted. As shown, cloud computing environment 50 includes one or more cloud computing nodes 10 with which local computing devices are used by cloud consumers, such as mobile device 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N are intended to be illustrative only and that computing nodes 10 and cloud computing environment 50 can communicate with any type of computerized device over any type of network and/or network addressable connection (e.g., using a web browser).

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and function 96. Function 96 in the present invention is the functionality of coordinating schedules of crawling documents based on metadata added to documents by text mining.

What is claimed is:

1. A computer-implemented method for coordinating schedules of crawling documents based on metadata added to documents by text mining, the method comprising:
determining whether added metadata in internal documents or metadata in original documents necessitates that the original documents in at least two of respective data sources be crawled by an application with a same crawling schedule;
in response to determining that the same crawling schedule is needed, changing respective crawling schedules of at least two of the respective data sources to the same crawling schedule; and
crawling the original documents in at least two of the respective data sources, according to the same crawling schedule.

2. The computer-implemented method of claim 1, wherein determining whether the same crawling schedule is needed and changing the respective crawling schedules to the same crawling schedule are implemented by a crawling scheduler.

3. The computer-implemented method of claim 2, wherein the crawling scheduler is integrated into the application.

4. The computer-implemented method of claim 2, wherein the crawling scheduler is a separate component from the application.

5. The computer-implemented method of claim 1, further comprising:
determining whether the internal documents which are converted from the original documents in at least two of the respective data sources are classified into a class; and
in response to determining that the internal documents are classified into the class, changing the respective crawling schedules of at least two of the respective data sources to the same crawling schedule.

6. The computer-implemented method of claim 1, further comprising:
determining whether the original documents in at least two of the respective data sources are with an access-control list; and
in response to determining that the original documents in at least two of the respective data sources are with the access-control list, changing the respective crawling schedules of at least two of the respective data sources to the same crawling schedule.

7. The computer-implemented method of claim 1, further comprising:
adding a label of the same crawling schedule to the original documents in at least two of the respective data sources.

8. A computer program product for coordinating schedules of crawling documents based on metadata added to documents by text mining, the computer program product comprising a computer readable storage medium having program instructions embodied therewith, the program instructions executable by one or more processors, the program instructions executable to:
determine whether added metadata in internal documents or metadata in original documents necessitates that the original documents in at least two of respective data sources be crawled by an application with a same crawling schedule;
in response to determining that the same crawling schedule is needed, change respective crawling schedules of at least two of the respective data sources to the same crawling schedule; and
crawl the original documents in at least two of the respective data sources, according to the same crawling schedule.

9. The computer program product of claim 8, wherein determining whether the same crawling schedule is needed and changing the respective crawling schedules to the same crawling schedule are implemented by a crawling scheduler.

10. The computer program product of claim 9, wherein the crawling scheduler is integrated into the application.

11. The computer program product of claim 9, wherein the crawling scheduler is a separate component from the application.

12. The computer program product of claim 8, further comprising the program instructions executable to:
determine whether the internal documents which are converted from the original documents in at least two of the respective data sources are classified into a class; and
in response to determining that the internal documents are classified into the class, change the respective crawling schedules of at least two of the respective data sources to the same crawling schedule.

13. The computer program product of claim 8, further comprising the program instructions executable to:
determine whether the original documents in at least two of the respective data sources are with an access-control list; and
in response to determining that the original documents in at least two of the respective data sources are with the access-control list, change the respective crawling schedules of at least two of the respective data sources to the same crawling schedule.

14. The computer program product of claim 8, further comprising the program instructions executable to:
add a label of the same crawling schedule to the original documents in at least two of the respective data sources.

15. A computer system for coordinating schedules of crawling documents based on metadata added to documents by text mining, the computer system comprising:
one or more processors, one or more computer readable tangible storage devices, and program instructions stored on at least one of the one or more computer readable tangible storage devices for execution by at least one of the one or more processors, the program instructions executable to:
determine whether added metadata in internal documents or metadata in original documents necessitates that the original documents in at least two of respective data sources be crawled by an application with a same crawling schedule;
in response to determining that the same crawling schedule is needed, change respective crawling schedules of at least two of the respective data sources to the same crawling schedule; and
crawl the original documents in at least two of the respective data sources, according to the same crawling schedule.

16. The computer system of claim 15, wherein determining whether the same crawling schedule is needed and changing the respective crawling schedules to the same crawling schedule are implemented by a crawling scheduler.

17. The computer system of claim 16, wherein the crawling scheduler is one of an integrated component of the application and a separate component from the application.

18. The computer system of claim 15, further comprising the program instructions executable to:
determine whether the internal documents which are converted from the original documents in at least two of the respective data sources are classified into a class; and
in response to determining that the internal documents are classified into the class, change the respective crawling schedules of at least two of the respective data sources to the same crawling schedule.

19. The computer system of claim 15, further comprising the program instructions executable to:
determine whether the original documents in at least two of the respective data sources are with an access-control list; and
in response to determining that the original documents in at least two of the respective data sources are with the access-control list, change the respective crawling schedules of at least two of the respective data sources to the same crawling schedule.

20. The computer system of claim 15, further comprising the program instructions executable to:
add a label of the same crawling schedule to the original documents in at least two of the respective data sources.
